(19) United States
(12) Patent Application Publication
(10) Pub. No.: US 2014/0253612 A1
(43) Pub. Date: Sep. 11, 2014

(54) DISPLAY DEVICE AND DRIVING METHOD THEREOF

(71) Applicant: Samsung Display Co., Ltd., Yongin-City (KR)

(72) Inventors: Young-In Hwang, Yongin-City (KR); Seong-Il Park, Yongin-City (KR)

(73) Assignee: Samsung Display Co., Ltd., Yongin-City (KR)

(21) Appl. No.: 13/961,879

(22) Filed: Aug. 7, 2013

(30) Foreign Application Priority Data
Mar. 11, 2013 (KR) 10-2013-0025734

(51) Int. Cl. G09G 3/32

(52) U.S. Cl. CPC G09G 3/3258
USPC 345/691; 345/77

(57) ABSTRACT

A display device includes: a plurality of pixels, each of the pixels including: a switching transistor; a relay transistor; a first capacitor; a driving transistor; and an organic light emitting diode (OLED). The OLED emits light according to a driving current from a first power source voltage, and a light emitting period for the OLED is one of a first light emitting period that is not temporally overlapped with a scan period in which data are written to the pixels or a second light emitting period that is temporally overlapped with the scan period. A duty of the light emitting period is controlled by controlling a time when a second power source voltage is applied as a low level voltage within the first light emitting period or controlling a time when the second power source voltage is applied as a low level voltage within the second light emitting period.

### CROSS-REFERENCE TO RELATED APPLICATION

This application claims priority to and the benefit of Korean Patent Application No. 10-2013-0025734 filed in the Korean Intellectual Property Office on Mar. 11, 2013, the entire contents of which are incorporated herein by reference.

### BACKGROUND

(a) Field

Aspects of the present invention relate to a display device and a driving method thereof.

(b) Description of Related Art

An organic light emitting diode (OLED) display uses organic light emitting diodes (OLEDs) having a luminance controlled by a current or a voltage. The organic light emitting diode includes an anode layer and a cathode layer for forming an electric field, and an organic light emitting material for emitting light in accordance with the electric field.

Generally, an organic light emitting diode display may be classified into a passive matrix OLED (PMOLED) and an active matrix OLED (AMOLED) according to a drive method.

Among these types of displays, in views of resolution, contrast, and operation speed, the AMOLED, which may be selectively turned on for every unit pixel, is mainly used.

One pixel of an active matrix OLED display may include an organic light emitting diode, a driving transistor for controlling a current amount supplied to the organic light emitting diode, and a switching transistor for transferring a data voltage that controls a light emitting amount of the organic light emitting diode to the driving transistor. The organic light emitting diode emits light with a light emitting amount (e.g., a predetermined light emitting amount) corresponding to a current amount supplied through the driving transistor.

An organic light emitting diode display displays an image by emitting light from a plurality of pixels during a light emitting period (e.g., a predetermined light emitting period) in a frame. The organic light emitting diode display may have a function permitting control of the overall (or entire) brightness of a screen, that is, the maximum luminance amount (or size). The light emitting period may be set to be constant with reference to the time when the maximum luminance amount (or size) of the organic light emitting diode display reaches a peak value.

When the maximum luminance amount (or size) of the organic light emitting diode display is not at the peak value, the pixels may emit light during the same light emitting period, and power consumption of the organic light emitting diode display may be increased unnecessarily.

Therefore, a method for adaptively controlling the light emitting period of the organic light emitting diode display may be beneficial.

The above information disclosed in this Background section is only for enhancement of understanding of the background of the invention and therefore it may contain information that does not form the prior art that is already known in this country to a person of ordinary skill in the art.

### SUMMARY

Aspects of embodiments of the present invention provide a display device for adaptively controlling a light emitting period and a driving method thereof.

An example embodiment of the present invention provides a display device including: a plurality of pixels, and each of the pixels includes: a switching transistor including a gate electrode for receiving a scan signal, a first electrode coupled to a data line, and a second electrode coupled to a first node; a relay transistor including a gate electrode for receiving a relay signal, a first electrode coupled to the first node, and a second electrode coupled to a second node; a first capacitor including a first electrode coupled to the second node and a second electrode coupled to a third node; a driving transistor including a gate electrode coupled to the third node, a first electrode coupled to a first power source voltage, and a second electrode coupled to a fourth node; and an organic light emitting diode (OLED) including an anode coupled to the fourth node and a cathode coupled to a second power source voltage. The OLED emits light according to a driving current flowing to the OLED from the first power source voltage, and a light emitting period for the OLED to emit light is one of a first light emitting period that is not temporally overlapped with a scan period in which data are written to the pixels or a second light emitting period that is temporally overlapped with the scan period. A duty of the light emitting period is controlled by controlling a time when the second power source voltage is applied as a low level voltage within the first light emitting period or controlling a time when the second power source voltage is applied as a low level voltage within the second light emitting period.

When the light emitting period is concurrently performed for the pixels, the relay transistor may be turned off, the switching transistor may be turned on by a scan signal having a gate-on voltage corresponding to the pixels, and a data voltage applied to the data line may be transmitted to the first node.

The duty of the light emitting period may be controlled according to a maximum luminance of a display unit including the pixels.

Each of the pixels may further include a compensation transistor including a gate electrode for receiving a compensation control signal, a first electrode coupled to the third node, and a second electrode coupled to the fourth node.

Each of the pixels may further include a reset transistor including a gate electrode for receiving the compensation control signal, a first electrode coupled to the data line, and a second electrode coupled to the second node.

Each of the pixels may further include a second capacitor including a first electrode coupled to the first power source voltage and a second electrode coupled to the second node.

Each of the pixels may further include a third capacitor including a first electrode coupled to the first node and a second electrode for receiving the compensation control signal.

Each of the pixels may further include a reset transistor including a gate electrode for receiving a reset signal, a first electrode coupled to the first power source voltage, and a second electrode coupled to the second node.

Each of the pixels may further include a second capacitor including a first electrode coupled to a reference voltage and a second electrode coupled to the first node.

Another embodiment of the present invention provides a display device including a plurality of pixels, and each of the pixels includes: a switching transistor including a gate electrode for receiving a first scan signal and a first electrode coupled to a data line; a compensation transistor including a gate electrode coupled to a first node, a first electrode coupled to a second electrode of the switching transistor, and a second electrode coupled to the first node; a relay transistor including a gate electrode for receiving a relay signal, a first electrode coupled to the first node, and a second electrode coupled to a second node; a driving transistor including a gate electrode coupled to the second node and a first electrode coupled to a first power source voltage; and an organic light emitting diode (OLED) including an anode coupled to a second electrode of the driving transistor and a cathode coupled to a second power source voltage. The OLED emits light according to a driving current flowing to the OLED from the first power source voltage, and a light emitting period for the OLED to emit light is one of a first light emitting period that is not temporally overlapped with a scan period in which data are written to the pixels or a second light emitting period that is temporally overlapped with the scan period. A duty of the light emitting period is controlled by controlling a time when the second power source voltage is applied as a low level voltage within the first light emitting period or controlling a time when the second power source voltage is applied as a low level voltage within the second light emitting period.

When the light emitting period is concurrently performed for the pixels, the relay transistor may be turned off, the switching transistor may be turned on by a scan signal having a gate-on voltage corresponding to the pixels, and a data voltage applied to the data line may be transmitted to the first node.

The duty of the light emitting period may be controlled according to a maximum luminance of a display unit including the pixels.

Each of the pixels may further include a first reset transistor including a gate electrode for receiving a second scan signal that is received before the first scan signal in a previous row, a first electrode coupled to a reference voltage, and a second electrode coupled to the first node.

Each of the pixels may further include the second reset transistor including a gate electrode for receiving a reset signal, a first electrode coupled to the reference voltage, and a second electrode coupled to the second node.

Each of the pixels may further include a first capacitor including a first electrode coupled to the first power source voltage and a second electrode coupled to the first node.

Each of the pixels may further include a second capacitor including a first electrode coupled to the first power source voltage and a second electrode coupled to the second node.

Another embodiment of the present invention provides a display device including a plurality of pixels, and each of the pixels includes: a switching transistor including a gate electrode for receiving a scan signal, a first electrode coupled to a data line, and a second electrode coupled to a first node; a relay transistor including a gate electrode for receiving a relay signal, a first electrode coupled to the first node, and a second electrode coupled to a second node; a driving transistor including a gate electrode coupled to a third node, a first electrode coupled to the second node, and a second electrode coupled to a fourth node; a first light emitting transistor including a gate electrode for receiving a light emitting signal, a first electrode coupled to a first power source voltage, and a second electrode coupled to the second node; and a second light emitting transistor including a gate electrode for receiving the light emitting signal, a first electrode coupled to the fourth node, and a second electrode coupled to an organic light emitting diode (OLED). The OLED emits light according to a driving current flowing to the OLED from the first power source voltage, and a light emitting period for the OLED to emit light is one of a first light emitting period that is not temporally overlapped with a scan period in which data are written to the pixels or a second light emitting period that is temporally overlapped with the scan period. A duty of the light emitting period is controlled by controlling a time when the light emitting signal is applied as a gate-on voltage within the first light emitting period or controlling a time when the light emitting signal is applied as a gate-on voltage within the second light emitting period.

When the light emitting period is concurrently performed for the pixels, the relay transistor may be turned off, the switching transistor may be turned on by a scan signal having a gate-on voltage corresponding to the pixels, and a data voltage applied to the data line may be transmitted to the first node.

The duty of the light emitting period may be controlled according to a maximum luminance of a display unit including the pixels.

Each of the pixels may further include a first reset transistor including a gate electrode for receiving a reset signal, a first electrode coupled to an initialization voltage, and a second electrode coupled to the third node.

Each of the pixels may further include a second reset transistor including a gate electrode for receiving the reset signal, a first electrode coupled to the first power source voltage, and a second electrode coupled to the second node.

Each of the pixels may further include a compensation transistor including a gate electrode for receiving the relay signal, a first electrode coupled to the third node, and a second electrode coupled to the fourth node.

Each of the pixels may further include a first capacitor including a first electrode coupled to the first node and a second electrode coupled to the initialization voltage.

Each of the pixels may further include a second capacitor including a first electrode coupled to the first power source voltage and a second electrode coupled to the third node.

Another embodiment of the present invention provides a method for driving a display device including a plurality of pixels, each of the pixels including a switching transistor for coupling a data line and a first node, a relay transistor for coupling the first node and a second node, a first capacitor coupled between the second node and a third node, and a driving transistor having a gate electrode coupled to the third node and configured to control a driving current flowing to an organic light emitting diode (OLED) from a first power source voltage, the method including: in a scan period of a first frame, turning off the relay transistor and turning on the switching transistor to transmit a data voltage applied to the data line to the first node; and in a light emitting period of the first frame, turning on the driving transistor according to a voltage at the third node and emitting light from the OLED according to the driving current. The voltage at the third node corresponds to a data voltage transmitted to the first node during a scan period of a frame that is before the first frame, and the pixels emit light during a light emitting period of the first frame, the light emitting period of the first frame being one of a first light emitting period that is not temporally overlapped with a scan period of the first frame or a second light emitting period that is temporally overlapped with the scan period of the first frame. A duty of the light emitting period of the first frame is controlled by controlling a time when a second power source voltage coupled to a cathode of the OLED is applied as a low level voltage within the first light emitting period or controlling a time when the second power source voltage is applied as a low level voltage within the second light emitting period.

The duty of the light emitting period may be controlled according to a maximum luminance of a display unit including the pixels.

Another embodiment of the present invention provides a method for driving a display device including a plurality of pixels, each of the pixels including a switching transistor for transmitting a data voltage to a first electrode of a compensation transistor having a gate electrode and a second electrode coupled to a first node, a relay transistor for coupling the first node and a second node, and a driving transistor having a gate electrode coupled to the second node and configured to control a driving current flowing to an organic light emitting diode (OLED) from a first power source voltage, the method including: in a scan period of a first frame, turning off the relay transistor and turning on the switching transistor and the compensation transistor to transmit the data voltage to the first node; and in a light emitting period of the first frame, turning on the driving transistor according to a voltage at the second node and emitting light from the OLED according to the driving current. The voltage at the second node corresponds to a data voltage transmitted to the first node during a scan period of a frame that is before the first frame, and the pixels emit light during a light emitting period of the first frame, the light emitting period of the first frame being one of a first light emitting period that is not temporally overlapped with a scan period of the first frame or a second light emitting period that is temporally overlapped with the scan period of the first frame. A duty of the light emitting period of the first frame is controlled by controlling a time when a second power source voltage coupled to a cathode of the OLED is applied as a low level voltage within the first light emitting period or controlling a time when the second power source voltage is applied as a low level voltage within the second light emitting period.

The duty of the light emitting period may be controlled according to a maximum luminance of a display unit including the pixels.

Another embodiment provides a method for driving a display device including a switching transistor for coupling a data line and a first node, a relay transistor for coupling the first node and a second node, a first light emitting transistor for coupling the second node and a first power source voltage, a capacitor coupled between the first power source voltage and a third node, a driving transistor having a gate electrode coupled to the third node and coupling the second node and a fourth node, and being configured to control a driving current flowing to an organic light emitting diode (OLED) from the first power source voltage, and a second light emitting transistor for coupling the fourth node and the OLED, the method including: in a scan period of a first frame, turning off the relay transistor and turning on the switching transistor to transmit a data voltage applied to the data line to the first node; and in a light emitting period of the first frame, turning on the first light emitting transistor and the second light emitting transistor according to a light emitting signal, turning on the driving transistor according to a voltage at the third node, and emitting light from the OLED according to the driving current. The voltage at the third node corresponds to a data voltage transmitted to the first node during a scan period of a frame that is before the first frame, and the pixels emit light during a light emitting period of the first frame, the light emitting period of the first frame being one of a first light emitting period that is not temporally overlapped with a scan period of the first frame or a second light emitting period that is temporally overlapped with the scan period of the first frame. A duty of the light emitting period of the first frame is controlled by controlling a time when the light emitting signal is applied as a gate-on voltage within the first light emitting period or controlling a time when the light emitting signal is applied as a gate-on voltage within the second light emitting period.

The duty of the light emitting period may be controlled according to a maximum luminance of a display unit including the pixels.

According to embodiments of the present invention, the light emitting period may be adaptively controlled depending on the maximum luminance amount (or size) of the display device, and power consumption of the display device may be resultantly reduced.

Further, the motion blur phenomenon that may occur when reproducing a motion picture may be improved (e.g., reduced) by controlling the light emitting period.

### BRIEF DESCRIPTION OF THE DRAWINGS

FIG. 1 shows a block diagram of a display device according to an example embodiment of the present invention.

FIG. 2 shows a circuit diagram of a pixel according to an example embodiment of the present invention.

FIG. 3 shows a timing diagram of a method for driving a display device according to an example embodiment of the present invention.

FIG. 4 shows a circuit diagram of a pixel according to another example embodiment of the present invention.

FIG. 5 shows a timing diagram of a method for driving a display device according to another example embodiment of the present invention.

FIG. 6 shows a circuit diagram of a pixel according to another example embodiment of the present invention.

FIG. 7 shows a timing diagram of a method for driving a display device according to another example embodiment of the present invention.

FIG. 8 shows a circuit diagram of a pixel according to another example embodiment of the present invention.

FIG. 9 shows a timing diagram of a method for driving a display device according to another example embodiment of the present invention.

### DETAILED DESCRIPTION

Aspects of the present invention will be described more fully hereinafter with reference to the accompanying drawings, in which example embodiments of the invention are shown. As those skilled in the art would realize, the described embodiments may be modified in various different ways, all without departing from the spirit or scope of the present invention.

Constituent elements having the same structures throughout the example embodiments are denoted by the same reference numerals and may be described in a first example embodiment. In other example embodiments, only other constituent elements may be described.

To more clearly describe example embodiments of the present invention, parts not related to the description may be omitted, and like reference numerals designate like constituent elements throughout the specification.

Throughout this specification and the claims that follow, when it is described that an element is “coupled” or “connected” to another element, the element may be “directly coupled” or “directly connected” to the other element or “electrically coupled” or “electrically connected” to the other element through a third element. In addition, unless explicitly described to the contrary, the word “comprise” and variations such as “comprises” or “comprising” will be understood to imply the inclusion of stated elements but not the exclusion of any other elements.

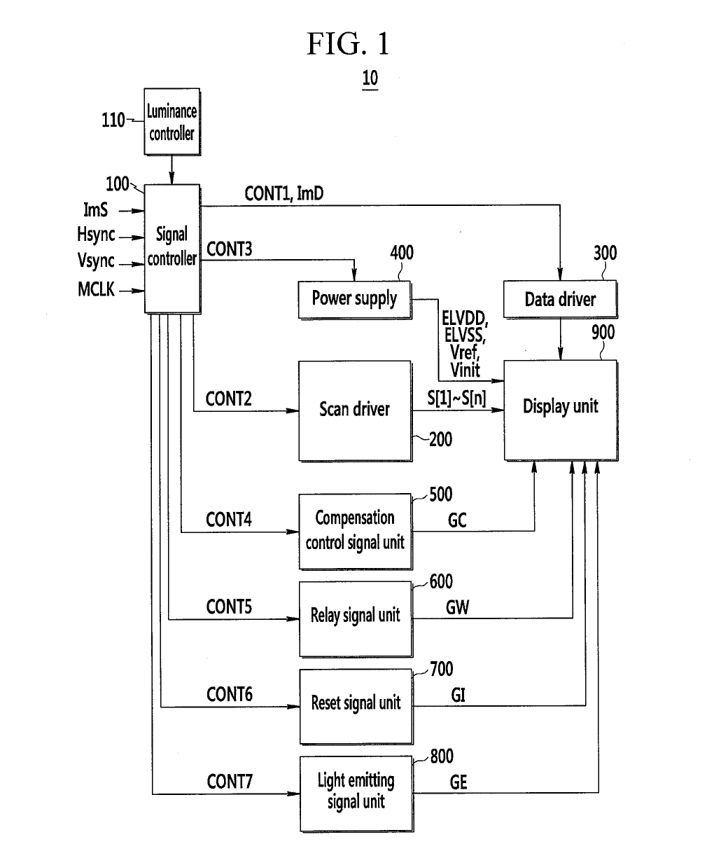

FIG. 1 shows a block diagram of a display device according to an example embodiment of the present invention.

Referring to FIG. 1, according to an embodiment the display device 10 includes a signal controller 100, a luminance controller 110, a scan driver 200, a data driver 300, a power supply 400, and a display unit 900. The display device 10 also includes at least one of a compensation control signal unit 500, a relay signal unit 600, a reset signal unit 700, and a light emitting signal unit 800 according to a configuration and a drive method of a plurality of pixels included in the display unit 900.

In one embodiment, the signal controller 100 receives an image signal (ImS) and a synchronizing signal from an external device. The image signal (ImS) includes luminance information of a plurality of pixels. The luminance may have a number (e.g., a predetermined number) of grays (e.g., 1024=2¹⁰, 256=2⁸, or 64=2⁶). The synchronizing signal includes a horizontal synchronization signal (Hsync), a vertical synchronization signal (Vsync), and a main clock signal (MCLK).

The signal controller 100 generates a plurality of drive control signals (CONT1 to CONT7) and an image data signal (ImD) according to the image signal (ImS), the horizontal synchronization signal (Hsync), the vertical synchronization signal (Vsync), and the main clock signal (MCLK).

The signal controller 100 distinguishes the image signal (ImS) for each frame according to the vertical synchronization signal (Vsync) and distinguishes the image signal (ImS) for each scan line according to the horizontal synchronization signal (Hsync) to generate the image data signal (ImD). The signal controller 100 transmits the image data signal (ImD) together with a first drive control signal (CONT1) to the data driver 300.

The signal controller 100 generates a third drive control signal (CONT3) transmitted to the power supply 400 and a seventh drive control signal (CONT7) transmitted to the light emitting signal unit 800 in consideration of the maximum luminance amount (or size) set by the luminance controller 110, and controls a light emitting period of a plurality of pixels, which will be described in detail later.

The luminance controller 110 controls an overall (or entire) brightness of the display unit 900, that is, its maximum luminance amount (or size). The maximum luminance amount (or size) may be set by a user instruction or a display mode, and the luminance controller 110 transmits a value (e.g., a set value) of a maximum luminance (e.g., a predetermined maximum luminance) to the signal controller 100.

According to one embodiment, the display unit 900 is a display area including a plurality of pixels substantially arranged in a matrix form. A plurality of scan lines that are substantially extended in a row direction and are substantially parallel with each other, a plurality of data lines that are substantially extended in a column direction and are substantially parallel with each other, and a plurality of power supply lines are formed on the display unit 900 so that they may be coupled to a plurality of pixels. At least one of a plurality of compensation control lines, a plurality of relay lines, a plurality of reset lines, and a plurality of light emitting lines are formed to be coupled to the pixels on the display unit 900 according to a configuration and a drive method of the pixels.

The scan driver 200 is coupled to the scan lines and generates a plurality of scan signals (S[1]-S[n]) according to the second drive control signal (CONT2). The scan driver 200 sequentially applies the scan signals (S[1]-S[n]) with a gate-on voltage to the scan lines.

The data driver 300 is coupled to a plurality of data lines, and samples and holds the image data signal (ImD) input according to the first drive control signal (CONT1), and transmits a plurality of data signals (data[1]-data[m]) to the data lines. The data driver 300 applies data signals (data[1]-data[m]) with a voltage range (e.g., a predetermined voltage range) to the data lines corresponding to the scan signals (S[1]-S[n]) with a gate-on voltage.

The power supply 400 determines levels of a first power source voltage (ELVDD) and a second power source voltage (ELVSS) according to the third drive control signal (CONT3), and supplies the same to the power supply lines coupled to the pixels. The first power source voltage (ELVDD) and the second power source voltage (ELVSS) supply a driving current of the pixels. The power supply 400 controls a time for applying the second power source voltage (ELVDD) as a low level voltage according to a value (e.g., a set value) of the maximum luminance, to control the light emitting period in which the pixels emit light. The power supply 400 may also supply a reference voltage (Vref) or an initialization voltage (Vinit) to an additional power supply line coupled to the pixels.

The compensation control signal unit 500 determines a level of a compensation control signal (GC) according to the fourth drive control signal (CONT4), and applies the same to the compensation control line coupled to the pixels.

The relay signal unit 600 determines a level of a relay signal (GW) according to the fifth drive control signal (CONT5) and applies the same to the relay line coupled to the pixels.

The reset signal unit 700 determines a level of a reset signal (GI) according to the sixth drive control signal (CONT6) and applies the same to the reset line coupled to the pixels.

The light emitting signal unit 800 determines a level of a light emitting signal (GE) according to the seventh drive control signal (CONT7) and applies the same to the light emitting line coupled to the pixels.

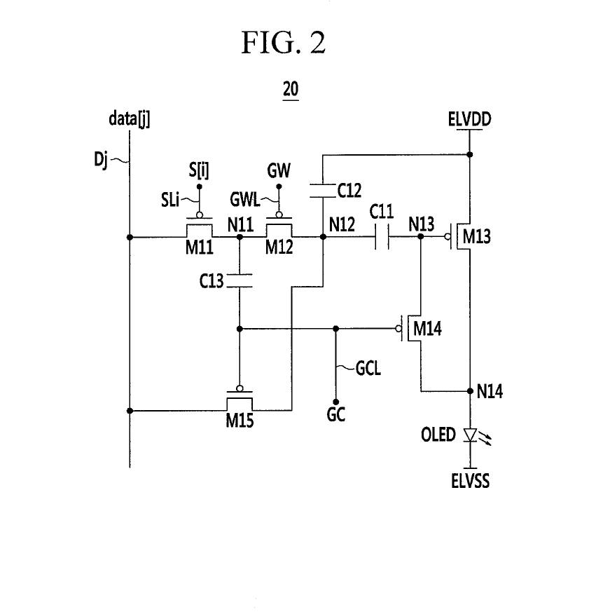

FIG. 2 shows a circuit diagram of a pixel according to an example embodiment of the present invention. In detail, FIG. 2 shows one of a plurality of pixels included in the display device 10 of FIG. 1.

Referring to FIG. 2, in one embodiment the pixel 20 includes a switching transistor (M11), a relay transistor (M12), a driving transistor (M13), a compensation transistor (M14), a reset transistor (M15), a first capacitor (C11), a second capacitor (C12), a third capacitor (C13), and an organic light emitting diode (OLED). When the pixels included in the display device 10 are of the type represented by the pixel 20 according to the first example embodiment, the display device 10 may not include the reset signal unit 700 and the light emitting signal unit 800.

The switching transistor (M11) includes a gate electrode coupled to the scan line (SLi), a first electrode coupled to the data line (Dj), and a second electrode coupled to the first node (N11). The switching transistor (M11) is turned on by the scan signal (S[i]) with a gate-on voltage applied to the scan line (SLi) and transmits the data voltage (data[j]) applied to the data line (Dj) to the first node (N11).

The relay transistor (M12) includes a gate electrode coupled to the relay line (GWL), a first electrode coupled to the first node (N11), and a second electrode coupled to the second node (N12). The relay transistor (M12) is turned on by the relay signal (GW) with a gate-on voltage applied to the relay line (GWL) and transmits a voltage at the first node (N11) to the second node (N12).

The first capacitor (C11) includes a first electrode coupled to the second node (N12) and a second electrode coupled to the second node (N13).

The driving transistor (M13) includes a gate electrode coupled to the third node (N13), a first electrode coupled to the first power source voltage (ELVDD), and a second electrode coupled to the fourth node (N14). An anode of an organic light emitting diode (OLED) is coupled to the fourth node (N14). The driving transistor (M13) controls a driving current supplied to the organic light emitting diode from the first power source voltage (ELVDD).

The compensation transistor (M14) includes a gate electrode coupled the compensation control line (GCL), a first electrode coupled to the third node (N13), and a second electrode coupled to the fourth node (N14). The compensation transistor (M14) is turned on by the compensation control signal (GC) with a gate-on voltage applied to the compensation control line (GCL) and couples the gate electrode of the driving transistor (M13) and the second electrode thereof.

The reset transistor (M15) includes a gate electrode coupled to the compensation control line (GCL), a first electrode coupled to the data line (Dj), and a second electrode coupled to the second node (N12). The reset transistor (M15) is turned on by the compensation control signal (GC) with a gate-on voltage applied to the compensation control line (GCL) and transmits a voltage applied to the data line (Dj) to the second node (N12).

The second capacitor (C12) includes a first electrode coupled to the first power source voltage (ELVDD) and a second electrode coupled to the second node (N12).

The third capacitor (C13) includes a first electrode coupled to the first node (N11) and a second electrode coupled to the compensation control line (GCL).

The organic light emitting diode includes an anode coupled to the fourth node (N14) and a cathode coupled to the second power source voltage (ELVSS). In one embodiment, the organic light emitting diode includes an organic emission layer for emitting light with one of the primary colors. The primary colors may include red, green, and blue, and desired colors may be expressed by a spatial sum or a temporal sum of the primary colors.

In one embodiment, the switching transistor (M11), the relay transistor (M12), the driving transistor (M13), the compensation transistor (M14), and the reset transistor (M15) are p-channel field effect transistors. In this instance, the gate-on voltage for turning on the switching transistor (M11), the relay transistor (M12), the driving transistor (M13), the compensation transistor (M14), and the reset transistor (M15) is a low level voltage, and the gate-off voltage for turning them off is a high level voltage.

In one embodiment, the p-channel field effect transistors are used, and at least one of the switching transistor (M11), the relay transistor (M12), the driving transistor (M13), the compensation transistor (M14), and the reset transistor (M15) is an n-channel field effect transistor. In this instance, the gate-on voltage for turning on the n-channel field effect transistor is a high level voltage, and the gate-off voltage for turning it off is a low level voltage.

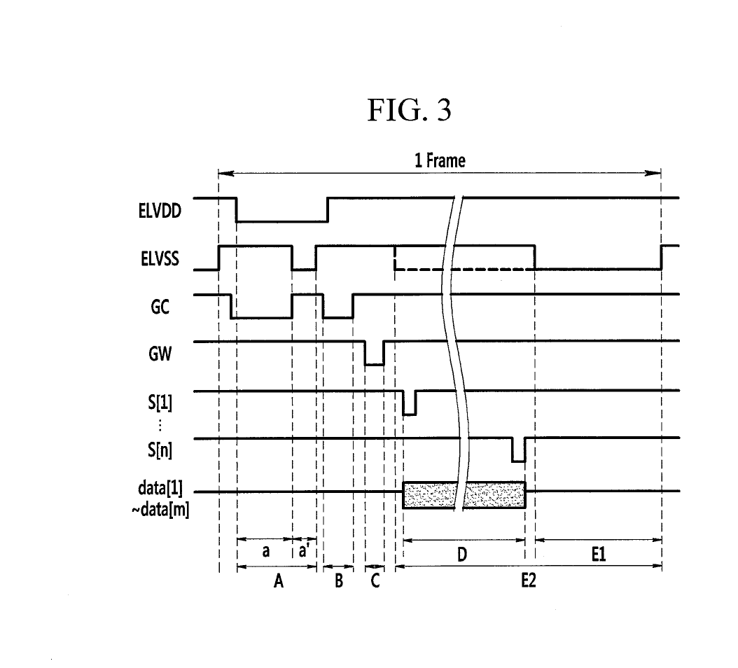

FIG. 3 shows a timing diagram of a method for driving a display device according to an example embodiment of the present invention. For example, FIG. 3 shows a method for driving a display device 10 including the pixel 20 according to the first example embodiment.

Referring to FIG. 1 to FIG. 3, one frame period for displaying an image to the display unit 900 includes: a reset period (A) for resetting the driving voltage of the organic light emitting diode of the pixel; a compensating period (B) for compensating a threshold voltage of the driving transistor of the pixel; a relay period (C) for relaying the data voltage stored in the pixels of the previous frame to the gate voltage of the driving transistor for light emission in the current frame; a scan period (D) for transmitting the data voltage to the pixels; and a light emitting period (E) for emitting light from the pixels corresponding to the data voltage relayed to the gate voltage of the driving transistor.

During a first reset period (a) included in the reset period (A), the first power source voltage (ELVDD) is applied as a low level voltage and the second power source voltage (ELVSS) is applied as a high level voltage. In this instance, the compensation control signal (GC) is applied as a gate-on voltage. The compensation transistor (M14) and the reset transistor (M15) are turned on by the compensation control signal (GC). The compensation transistor (M14) is turned on, and the gate electrode and the second electrode of the driving transistor (M13) are coupled. The reset transistor (M15) is turned on, and the voltage applied to the data line (Dj) is transmitted to the second node (N12). In this instance, a reset voltage (e.g., a predetermined reset voltage) is applied to the data line (Dj), and a voltage at the second node (N12) is reset by the reset voltage. For example, the voltage stored in the second capacitor (C12) in the previous frame may be reset by the reset voltage. The reset voltage can be a low level voltage. When the voltage at the second node (N12) is reset by the reset voltage, a voltage at the third node (N13) is changed into a low level voltage by coupling by the first capacitor (C11), and the driving transistor (M13) is turned on. Accordingly, a current flows to the first power source voltage (ELVDD) from the fourth node (N14) and the voltage at the fourth node (N14) is reduced. That is, the anode voltage of the organic light emitting diode is reset as the low level voltage.

During a second reset period (a′) included in the reset period (A), the first power source voltage (ELVDD) is applied as a low level voltage, and the second power source voltage (ELVSS) is changed into a low level voltage. In this instance, the compensation control signal (GC) is applied as a gate-off voltage, and the compensation transistor (M14) and the reset transistor NM15 are turned off. As the second power source voltage (ELVSS) is changed to a low level voltage, the voltage at the fourth node (N14) is reset as a lower voltage by coupling caused by a parasitic capacitance of the organic light emitting diode (OLED).

During the compensating period (B), the first power source voltage (ELVDD) and the second power source voltage (ELVSS) are applied as a high level voltage. In this instance, the compensation control signal (GC) is applied as a gate-on voltage. The compensation transistor (M14) and the reset transistor (M15) are turned on by the compensation control signal (GC). In this instance, a sustain voltage (e.g., a predetermined sustain voltage) may be applied to the data line (Dj). A sustain voltage may be equal or similar to a reset voltage. When the reset transistor (M15) is turned on, the sustain voltage is applied to the second node (N12). When the compensation transistor (M14) is turned on, the driving transistor (M13) is diode-coupled, and a threshold voltage of the driving transistor (M13) is transmitted to the third node (N13). Hence, the threshold voltage of the driving transistor (M13) is stored in the first capacitor (C11), and the threshold voltage of the driving transistor (M13) may be compensated. In this instance, the second power source voltage (ELVSS) is applied as a high level voltage so the organic light emitting diode (OLED) emits no light.

During the relay period (C), the first power source voltage (ELVDD) and the second power source voltage (ELVSS) are applied as a high level voltage. In this instance, the relay signal (GW) is applied as a gate-on voltage. The relay transistor (M12) is turned on by the relay signal (GW). When the relay transistor (M12) is turned on, the first node (N11) is coupled to the second node (N12), and the voltage stored in the third capacitor (C13) is transmitted to the second node (N12). The data voltage applied in the previous frame is stored in the third capacitor (C13). That is, the data voltage applied in the previous frame is transmitted to the second node (N12). Therefore, the voltage at the third node (N13) is changed by the change of the voltage at the second node (N12) into the data voltage by the coupling by the first capacitor (C11). That is, the data voltage is applied to the third node (N13).

After the data voltage of the previous frame is transmitted to the second node (N12), the relay signal (GW) is applied as a gate-off voltage and the first node (N11) is disconnected from the second node (N12).

During the scan period (D), a plurality of scan signals (S[1]-S[n]) with a gate-on voltage are sequentially applied to a plurality of scan lines, and a plurality of data voltages (data[1]-data[m]) are applied in correspondence to this. The switching transistor (M11) is turned on by the scan signal (S[i]) with a gate-on voltage, and the data voltage (data[j]) applied to the data line (Dj) is transmitted to the first node (N11) through the turned on switching transistor (M11). Accordingly, the data voltage (data[j]) is stored in the third capacitor (C13). The data voltage (data[j]) stored in the third capacitor (C13) is used for light emission in the next frame.

The light emitting period (E) is set to be a time when the second power source voltage (ELVSS) is changed and applied as a low level voltage while the first power source voltage (ELVDD) is applied as a high level voltage. When the second power source voltage (ELVSS) is applied as a low level voltage, the driving transistor (M13) is turned on, and a driving current flows to the organic light emitting diode (OLED) from the first power source voltage (ELVDD). The driving current flows with a current amount that corresponds to the data voltage applied to the third node (N13). The organic light emitting diode (OLED) emits light with brightness that corresponds to the current amount. In one embodiment, the light emitting period (E) is applied to a plurality of pixels that concurrently (e.g., simultaneously) emit light.

The light emitting period (E) may be set as one of the first light emitting period (E1) or the second light emitting period (E2).

The first light emitting period (E1) represents a period up to a frame finishing point after the scan period (D) in which data writing is finished. For example, the first light emitting period (E1) is not temporally overlapped with the scan period (D). The first light emitting period (E1) may occupy about (or substantially) 40% of one frame. In one embodiment, when the light emitting period (E) is set as the first light emitting period (E1), a duty of the light emitting period (E) is controlled by controlling the time when the second power source voltage (ELVSS) is applied as a low level voltage within the first light emitting period (E1). That is, the duty of the light emitting period (E) may be controllable within a 0 to 40% range of one frame.

The second light emitting period (E2) represents a period from before a time when the scan period (D) starts to the frame finishing point. The second light emitting period (E2) is overlapped with the scan period (D) with respect to time. The second light emitting period (E2) may occupy about (or substantially) 80% of one frame. In this instance, the scan period (D) may occupy about (or substantially) 40% of one frame. In one embodiment, when the light emitting period (E) is set as the second light emitting period (E2), the duty of the light emitting period (E) is controlled by controlling the time when the second power source voltage (ELVSS) is applied as a low level voltage during the second light emitting period (E2). In this instance, the time for the second power source voltage (ELVSS) to be changed to the high level voltage from the low level voltage is set within the time that is not overlapped with the scan time (D), that is, within the E1 time domain. That is, the duty of the light emitting period (E) may be controllable with the 40 to 80% range of one frame.

Accordingly, when the light emitting period (E) is set to be one of the first light emitting period (E1) or the second light emitting period (E2), the time in which the second power source voltage (ELVSS) is changed is not overlapped with the scan period (D) with respect to time. When the time in which the second power source voltage (ELVSS) is changed is temporally overlapped with the scan period (D), the scan signal may not be normally output and a horizontal dark line may be generated by coupling between a power supply line of the second power source voltage (ELVSS) and the scan line.

When the light emitting period (E) is selected from one of the first light emitting period (E1) or the second light emitting period (E2) and the time in which the second power source voltage (ELVSS) is changed is not temporally overlapped with the scan period (D) according to the display device driving method of embodiments of the present invention, the duty of the light emitting period (E) may be controlled without influencing image quality.

The duty of the light emitting period (E) may be controlled to correspond to the maximum luminance amount (or size) of the display unit 900. For example, assuming that the maximum luminance amount (or size) of the display unit 900 may be controlled by 60% to 100%, when the maximum luminance of the display unit 900 is set to be 60% (the lowest), the light emitting period (E) may be set as the first light emitting period (E1), and when the maximum luminance of the display unit 900 is set to be 100% (the highest), the light emitting period (E) may be set as the second light emitting period (E2). The duty of the light emitting period (E) may be adaptively controlled according to the maximum luminance amount (or size) of the display device 10 so that power consumption of the display device 10 may be reduced.

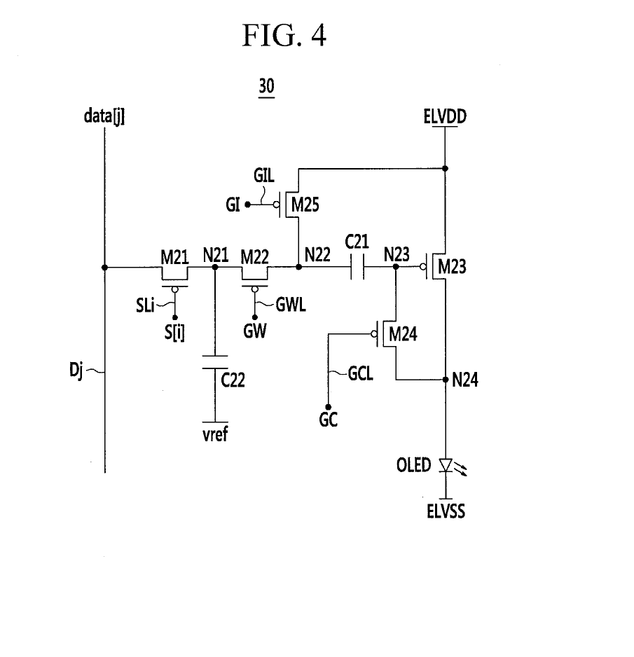

FIG. 4 shows a circuit diagram of a pixel according to another example embodiment of the present invention. The pixel represents one of a plurality of pixels included in the display device 10 of FIG. 1.

Referring to FIG. 4, the pixel 30 according to a second example embodiment includes a switching transistor (M21), a relay transistor (M22), a driving transistor (M23), a compensation transistor (M24), a reset transistor (M25), a first capacitor (C21), a second capacitor (C22), and an organic light emitting diode (OLED). When the pixels included in the display device 10 are of the type represented by the pixel 30 according to the second example embodiment, the display device 10 may not include a light emitting signal unit 800.

The switching transistor (M21) includes a gate electrode coupled to a scan line (SLi), a first electrode coupled to a data line (Dj), and a second electrode coupled to a first node (N21). The switching transistor (M21) is turned on by the scan signal (S[i]) with a gate-on voltage applied to the scan line (SLi) and transmits a data voltage (data[j]) applied to the data line (Dj) to the first node (N21).

The relay transistor (M22) includes a gate electrode coupled to a relay line (GWL), a first electrode coupled to the first node (N21), and a second electrode coupled to a second node (N22). The relay transistor (M22) is turned on by a relay signal (GW) with a gate-on voltage applied to the relay line (GWL) and transmits a voltage at the first node (N21) to the second node (N22).

The first capacitor (C21) includes a first electrode coupled to the second node (N22) and a second electrode coupled to the third node (N23).

The second capacitor (C22) includes a first electrode coupled to a reference voltage (Vref) and a second electrode coupled to the first node (N21).

The driving transistor (M23) includes a gate electrode coupled to the third node (N23), a first electrode coupled to the first power source voltage (ELVDD), and a second electrode coupled to the fourth node (N24). The fourth node (N24) is coupled to an anode of the organic light emitting diode (OLED). The driving transistor (M23) controls a driving current supplied to the organic light emitting diode (OLED) from the first power source voltage (ELVDD).

The compensation transistor (M24) includes a gate electrode coupled to a compensation control line (GCL), a first electrode coupled to the third node (N23), and a second electrode coupled to the fourth node (N24). The compensation transistor (M24) is turned on by a compensation control signal (GC) with a gate-on voltage applied to the compensation control line (GCL) and couples the gate electrode of the driving transistor (M23) and the second electrode of the driving transistor (M23).

The reset transistor (M25) includes a gate electrode coupled to a reset line (GIL), a first electrode coupled to the first power source voltage (ELVDD), and a second electrode coupled to the second node (N22). The reset transistor (M25) is turned on by a reset signal (GI) with a gate-on voltage applied to the reset line (GIL) and transmits the first power source voltage (ELVDD) to the second node (N22).

The organic light emitting diode (OLED) includes an anode coupled to the fourth node (N24) and a cathode coupled to the second power source voltage (ELVSS). In one embodiment, the organic light emitting diode (OLED) includes an organic emission layer for emitting light of one of the primary colors. The primary colors may include red, green, and blue, and desired colors may be displayed by a spatial or temporal sum of the primary colors.

In one embodiment, the switching transistor (M21), the relay transistor (M22), the driving transistor (M23), the compensation transistor (M24), and the reset transistor (M25) may be p-channel field effect transistors. In this instance, the gate-on voltage for turning on the switching transistor (M21), the relay transistor (M22), the driving transistor (M23), the compensation transistor (M24), and the reset transistor (M25) is a low level voltage, and the gate-off voltage for turning them off is a high level voltage.

While the p-channel field effect transistors are shown in the embodiment of FIG. 4, at least one of the switching transistor (M21), the relay transistor (M22), the driving transistor (M23), the compensation transistor (M24), and the reset transistor (M25) may be an n-channel field effect transistor. In this instance, the gate-on voltage for turning on the n-channel field effect transistor is a high level voltage, and the gate-off voltage for turning it off is a low level voltage.

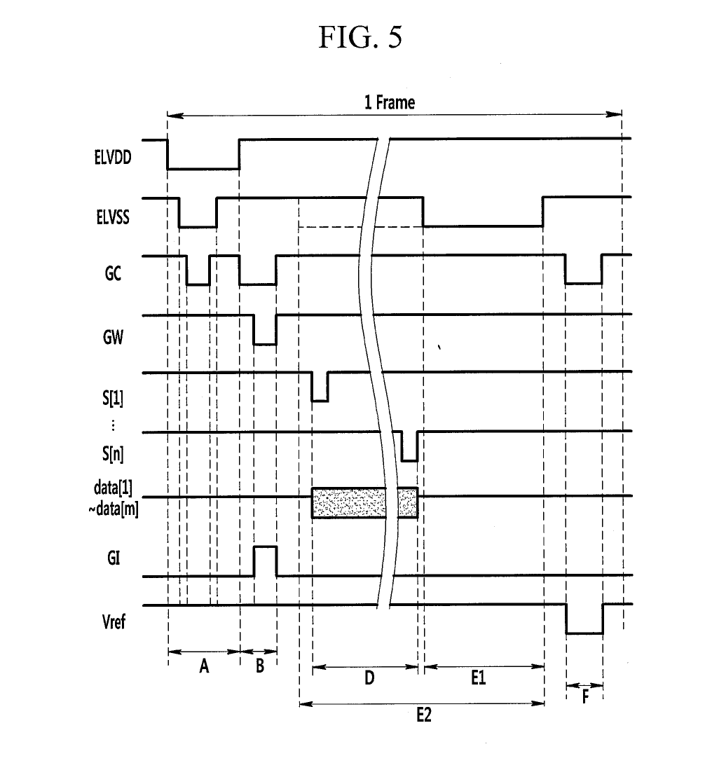

FIG. 5 shows a timing diagram of a method for driving a display device according to another example embodiment of the present invention. A method for driving a display device 10 including a pixel 30 according to a second example embodiment is shown.

Referring to FIG. 1, FIG. 4, and FIG. 5, one frame period during which an image is displayed to the display unit 900 includes: a reset period (A) for resetting a driving voltage of an organic light emitting diode (OLED) of a pixel; a compensating period (B) for compensating a threshold voltage of a driving transistor of a pixel; a scan period (D) for transmitting a data voltage to a plurality of pixels; a light emitting period (E) for emitting light from a plurality of pixels corresponding to the data voltage applied to a gate voltage of the driving transistor; and a bias period (F) for improving a response waveform of a plurality of pixels.

During the reset period (A), the first power source voltage (ELVDD) is applied as a low level voltage. During the reset period (A), the second power source voltage (ELVSS) is changed to the low level voltage from the high level voltage. As the second power source voltage (ELVSS) is varied to the low level voltage from the high level voltage, a voltage at the fourth node (N24) becomes the low level voltage by coupling caused by a parasitic capacitance of the organic light emitting diode (OLED). During the first reset period (a″), the compensation control signal (GC) is applied as a gate-on voltage and the compensation transistor (M24) is turned on. As the compensation transistor (M24) is turned on, the third node (N23) is coupled to the fourth node (N24) and the voltage at the fourth node (N24) becomes a low level voltage. After the voltage at the fourth node (N24) becomes a low level voltage, the compensation control signal (GC) is applied as a gate-off voltage and the compensation transistor (M24) is turned off. After the compensation transistor (M24) is turned off, the second power source voltage (ELVSS) is varied to a high level voltage. As the second power source voltage (ELVSS) is changed to the high level voltage, the voltage at the fourth node (N24) becomes a high level voltage by coupling caused by the parasitic capacitance of the organic light emitting diode (OLED). As the voltage at the fourth node (N24) is varied to the high level voltage while the voltage at the third node (N23) is at the low level voltage, the driving transistor (M23) is turned on and the current flows to the first power source voltage (ELVDD) from the fourth node (N24). Accordingly, the voltage at the fourth node (N24) is reduced to be the low level voltage. That is, the anode voltage of the organic light emitting diode (OLED) is reset as the low level voltage.

During the compensating period (B), the first power source voltage (ELVDD), and the second power source voltage (ELVSS) are applied as a high level voltage. In this instance, the compensation control signal (GC) is applied as the gate-on voltage. The compensation transistor (M24) is turned on by the compensation control signal (GC). As the compensation transistor (M24) is turned on, the driving transistor (M23) is diode-coupled and the threshold voltage of the driving transistor (M23) is applied to the third node (N23). Accordingly, the voltage to which the threshold voltage of the driving transistor (M23) is applied is stored in the first capacitor (C21). That is, the threshold voltage of the driving transistor (M23) may be compensated. The relay signal (GW) is applied as a gate-on voltage. The reset signal (GI) is applied as a gate-on voltage during a period except the period in which the relay signal (GW) is applied as the gate-on voltage. That is, when the relay signal (GW) is applied as the gate-on voltage, the reset signal (GI) is applied as the gate-off voltage. The relay transistor (M22) is turned on by the relay signal (GW) with a gate-on voltage. As the relay transistor (M22) is turned on, the first node (N21) is coupled to the second node (N22), and the voltage stored in the second capacitor (C22) is transmitted to the second node (N22). The second capacitor (C22) stores the data voltage that is applied in the previous frame. That is, the data voltage that is applied in the previous frame is transmitted to the second node (N22). As the data voltage is transmitted to the second node (N22), the voltage at the third node (N23) is varied by a varied value of the voltage at the second node (N22) to the data voltage caused by coupling by the first capacitor (C21). That is, the data voltage is applied to the third node (N23). In this instance, the second power source voltage (ELVSS) is applied as the high level voltage so the organic light emitting diode (OLED) does not emit light.

During the scan period (D), a plurality of scan signals (S[1]-S[n]) with a gate-on voltage are sequentially applied to a plurality of scan lines, and a plurality of corresponding data voltages (data[1]-data[m]) are applied. The switching transistor (M21) is turned on by the scan signal (S[i]) with a gate-on voltage, and the data voltage (data[j]) applied to the data line (Dj) is transmitted to the first node (N21) through the turned on switching transistor (M21). Accordingly, the data voltage (data[j]) is stored in the second capacitor (C22). The data voltage (data[j]) stored in the second capacitor (C22) is used for light emission in the next frame.

The light emitting period (E) is set as a time when the second power source voltage (ELVSS) is varied as a low level voltage and is applied while the first power source voltage (ELVDD) is applied as a high level voltage. When the second power source voltage (ELVSS) is applied as a low level voltage, the driving transistor (M23) is turned on and a driving current flows to the organic light emitting diode (OLED) from the first power source voltage (ELVDD). The driving current flows with a current amount that corresponds to the data voltage applied to the third node (N23). The organic light emitting diode (OLED) emits light corresponding to the current amount. In one embodiment, the light emitting period (E) is performed for a plurality of pixels which concurrently (e.g., simultaneously) emit light.

The light emitting period (E) may be set as one of the first light emitting period (E1) or the second light emitting period (E2).

The first light emitting period (E1) represents a period up to a frame finishing point after the scan period (D) in which data writing is finished. For example, the first light emitting period (E1) is not temporally overlapped with the scan period (D). The first light emitting period (E1) may occupy about (or substantially) 40% of one frame. In one embodiment, when the light emitting period (E) is set as the first light emitting period (E1), a duty of the light emitting period (E) is controlled by controlling the time when the second power source voltage (ELVSS) is applied as a low level voltage within the first light emitting period (E1). That is, the duty of the light emitting period (E) may be controllable within a 0 to 40% range of one frame.

The second light emitting period (E2) represents a period from before a time when the scan period (D) starts to the frame finishing point. The second light emitting period (E2) is overlapped with the scan period (D) with respect to time. The second light emitting period (E2) may occupy about (or substantially) 80% of one frame. In this instance, the scan period (D) may occupy about (or substantially) 40% in one frame. In one embodiment, when the light emitting period (E) is set as the second light emitting period (E2), the duty of the light emitting period (E) is controlled by controlling the time when the second power source voltage (ELVSS) is applied as a low level voltage during the second light emitting period (E2). In this instance, the time for the second power source voltage (ELVSS) to be changed to the high level voltage from the low level voltage is set within the time that is not overlapped with the scan time (D), that is, within the E1 time domain. That is, the duty of the light emitting period (E) may be controllable with the 40 to 80% range of one frame.

Accordingly, when the light emitting period (E) is set to be one of the first light emitting period (E1) or the second light emitting period (E2), the time in which the second power source voltage (ELVSS) is changed is not overlapped with the scan period (D) with respect to time. Therefore, the display device 10 according to an embodiment of the present invention may control the duty of the light emitting period (E) while preventing generation of the horizontal dark line caused by temporal superposition of the scan period (D) over the time when the second power source voltage (ELVSS) is varied.

As described with reference to FIG. 3, the duty of the light emitting period (E) may be controllable to correspond to the maximum luminance amount (or size) of the display unit 900.

During the bias period (F), the first power source voltage (ELVDD) and the second power source voltage (ELVSS) are applied as a high level voltage and the reference voltage (Vref) is applied as a low level voltage. The reference voltage (Vref) is applied as a high level voltage for a period except the bias period (F) in one frame. As the reference voltage (Vref) is varied to the low level voltage, the voltage at the first node (N21) is varied by a voltage variation amount of the reference voltage (Vref). The compensation control signal (GC) is applied as a low level voltage. The compensation transistor (M24) is turned on by the compensation control signal (GC), and the third node (N23) is coupled to the fourth node (N24). Accordingly, the voltages at the third node (N23) and the fourth node (N24) are reset at a voltage (e.g., as a specific voltage). The gate, source, and drain voltages of the driving transistor (M23) are applied as the voltage (e.g., the specific voltage), and a response waveform of the pixel may be improved. According to an embodiment of the present invention, the bias period (F) may be omitted.

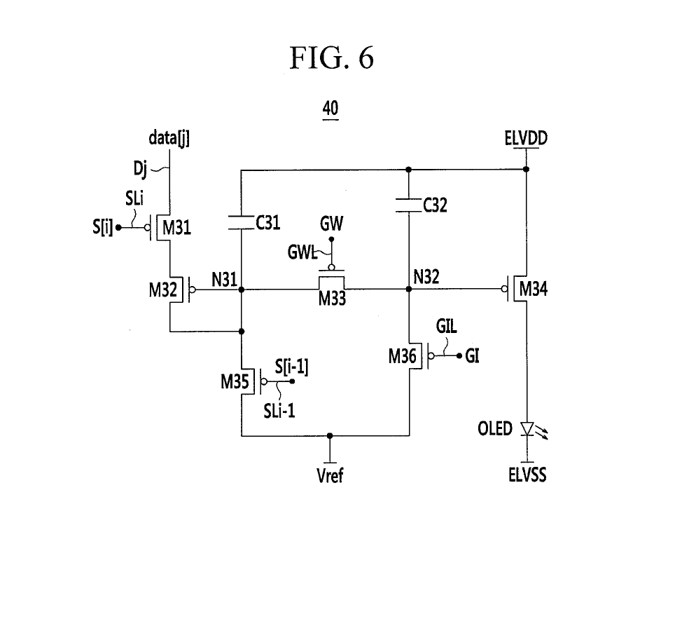

FIG. 6 shows a circuit diagram of a pixel according to another example embodiment of the present invention, showing one of a plurality of pixels that may be included in the display device 10 of FIG. 1.

Referring to FIG. 6, the pixel 40 according to a third example embodiment includes a switching transistor (M31), a compensation transistor (M32), a relay transistor (M33), a driving transistor (M34), a first reset transistor (M35), a second reset transistor (M36), a first capacitor (C31), a second capacitor (C32), and an organic light emitting diode. When the pixels included in the display device 10 are of the type represented by the pixel 40 according to the third example embodiment, the display device 10 may not include the compensation control signal unit 500 and the light emitting signal unit 800.

The switching transistor (M31) includes a gate electrode coupled to a first scan line (SLi), a first electrode coupled to a data line (Dj), and a second electrode coupled to a first electrode of the compensation transistor (M32). The switching transistor (M21) is turned on by a first scan signal (S[i]) with a gate-on voltage applied to the first scan line (SLi) and transmits a data voltage (data[j]) applied to the data line (Dj) to the compensation transistor (M32).

The compensation transistor (M32) includes a gate electrode coupled to a first node (N31), a first electrode coupled to a second electrode of the switching transistor (M31), and a second electrode coupled to the first node (N31). The compensation transistor (M32) is diode-coupled to compensate the threshold voltage.

The relay transistor (M33) includes a gate electrode coupled to a relay line (GWL), a first electrode coupled to the first node (N31), and a second electrode coupled to the second node (N32). The relay transistor (M33) is turned on by a relay signal (GW) with a gate-on voltage applied to the relay line (GWL) and transmits a voltage at the first node (N31) to the second node (N32).

The driving transistor (M34) includes a gate electrode coupled to the second node (N32), a first electrode coupled to the first power source voltage (ELVDD), and a second electrode coupled to the organic light emitting diode. The driving transistor (M34) controls the driving current supplied to the organic light emitting diode from the first power source voltage (ELVDD).

The first reset transistor (M35) includes a gate electrode coupled to a second scan line (SLi−1), a first electrode coupled to a reference voltage (Vref), and a second electrode coupled to the first node (N31). The first reset transistor (M35) is turned on by a second scan signal (S[i−1]) with a gate-on voltage applied to the second scan line (SLi−1) and transmits the reference voltage (Vref) to the first node (N31). The second scan line (SLi−1) is arranged before the first scan line (SLi) by one row (e.g., in a previous row), and the second scan signal (S[i−1]) is applied before the first scan signal (S[i]) by one row.

The second reset transistor (M36) includes a gate electrode coupled to a reset line (GIL), a first electrode coupled to a reference voltage (Vref), and a second electrode coupled to the second node (N32). The second reset transistor (M36) is turned on by a reset signal (GI) with a gate-on voltage applied to the reset line (GIL) and transmits the reference voltage (Vref) to the second node (N32).

The first capacitor (C31) includes a first electrode coupled to the first power source voltage (ELVDD) and a second electrode coupled to the first node (N31).

The second capacitor (C32) includes a first electrode coupled to the first power source voltage (ELVDD) and a second electrode coupled to the second node (N32).

The organic light emitting diode includes an anode coupled to the second electrode of the driving transistor (M34) and a cathode coupled to the second power source voltage (ELVSS). In one embodiment, the organic light emitting diode includes an organic emission layer for emitting light of one of the primary colors. The primary colors may include red, green, and blue, and desired colors may be expressed by a spatial sum or a temporal sum of the primary colors.

In one embodiment, the switching transistor (M31), the compensation transistor (M32), the relay transistor (M33), the driving transistor (M34), the first reset transistor (M35), and the second reset transistor (M36) may be p-channel field effect transistors. In this instance, the gate-on voltage for turning on the switching transistor (M31), the compensation transistor (M32), the relay transistor (M33), the driving transistor (M34), the first reset transistor (M35), and the second reset transistor (M36) is a low level voltage, and the gate-off voltage for turning them off is a high level voltage.

While the p-channel field effect transistors are used in the embodiment of FIG. 6, at least one of the switching transistor (M31), the compensation transistor (M32), the relay transistor (M33), the driving transistor (M34), the first reset transistor (M35), and the second reset transistor (M36) may be an n-channel field effect transistor. In this instance, the gate-on voltage for turning on the n-channel field effect transistor is a high level voltage, and the gate-off voltage for turning it off is a low level voltage.

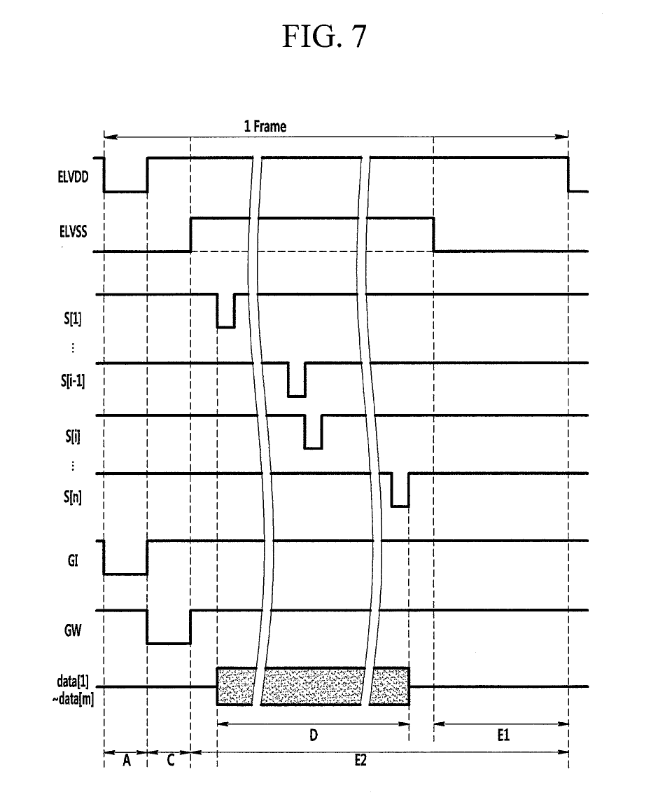

FIG. 7 shows a timing diagram of a method for driving a display device according to another example embodiment of the present invention. That is, a method for driving the display device 10 including the pixel 40 according to the third example embodiment is shown.

Referring to FIG. 1, FIG. 6, and FIG. 7, one frame period for displaying an image to the display unit 900 includes: a reset period (A) for resetting the driving voltage of the organic light emitting diode of the pixel; a relay period (C) for relaying the data voltage stored in the pixels of the previous frame to the gate voltage of the driving transistor for light emission in the current frame; a scan period (D) for transmitting the data voltage to the pixels; and a light emitting period (E) for emitting light from the pixels corresponding to the data voltage relayed to the gate voltage of the driving transistor.

During the reset period (A), the first power source voltage (ELVDD) and the second power source voltage (ELVSS) are applied as a low level voltage. In this instance, a reset signal (GI) is applied as a gate-on voltage. The second reset transistor (M36) is turned on by the reset signal (GI), and a reference voltage (Vref) is transmitted to the second node (N32).

In one embodiment, the reference voltage (Vref) is a low level voltage. The anode voltage of the organic light emitting diode is greater than the low level voltage due to the driving current that flows to the organic light emitting diode (OLED) from the first power source voltage (ELVDD) with a high level voltage in the previous frame. When a voltage at the second node (N32) becomes a low level voltage, the driving transistor (M34) is turned on. The current flows to the first power source voltage (ELVDD) from the anode of the organic light emitting diode, and the anode voltage of the organic light emitting diode is reset as a low level voltage.

During the relay period (C), the first power source voltage (ELVDD) is applied as a high level voltage and the second power source voltage (ELVSS) is applied as a low level voltage. In this instance, the relay signal (GW) is applied as a gate-on voltage. The relay transistor (M33) is turned on by the relay signal (GW). As the relay transistor (M33) is turned on, the first node (N31) is coupled to the second node (N32) and the voltage stored in the first capacitor (C31) is transmitted to the second node (N32). The first capacitor (C31) stores the data voltage applied in the previous frame. That is, the data voltage applied in the previous frame is transmitted to the second node (N32). The voltage stored in the first capacitor (C31) will be described later when the scan period (D) is described.

After the data voltage of the previous frame is transmitted to the second node (N32), the relay signal (GW) is applied as a gate-off voltage and the first node (N31) is disconnected from the second node (N32).

During the scan period (D), a plurality of scan signals (S[1]-S[n]) with a gate-on voltage are sequentially applied to a plurality of scan lines, and a plurality of corresponding data voltages (data[1]-data[m]) are applied. The first reset transistor (M35) is turned on by the second scan signal (S[i−1]) with a gate-on voltage, and the reference voltage (Vref) is transmitted to the first node (N31) through the turned on first reset transistor (M35). The voltage at the first node (N31) is reset with the reference voltage (Vref). The switching transistor (M31) is turned on by the first scan signal (S[i]) with a gate-on voltage, and the data voltage (data[j]) applied to the data line (Dj) is transmitted to the compensation transistor (M32) through the turned on switching transistor (M31). Since the reference voltage (Vref) is a low level voltage, the compensation transistor (M32) is turned on and the data voltage (data[j]) is transmitted to the first node (N31). In this instance, the compensation transistor (M32) is diode-coupled so that the data voltage (data[j]) and the threshold voltage of the compensation transistor (M32) are transmitted to the first node (N31). In one embodiment, the compensation transistor (M32) is configured in a like manner to the driving transistor (M34), and it has a similar (or very similar) characteristic to the driving transistor (M34). Therefore, the threshold voltage of the compensation transistor (M32) is similar (or very similar) to the threshold voltage of the driving transistor (M34). It can be accordingly said that, in one embodiment, the data voltage (data[j]) and the threshold voltage of the driving transistor (M34) are applied to the first node (N31). The voltage at the first node (N31) to which the data voltage (data[j]) and the threshold voltage of the driving transistor (M34) are applied is stored in the first capacitor (C31). The voltage stored in the first capacitor (C31) is used for light emission in the next frame.

The light emitting period (E) is set as a time when the voltage stored in the first capacitor (C31) in the relay period (C) is transmitted to the second node (N32) to turn on the driving transistor (M34) and the driving current flows to the organic light emitting diode from the first power source voltage (ELVDD). The driving current flows with a current amount that corresponds to the data voltage transmitted to the second node (N32). The organic light emitting diode (OLED) emits light corresponding to the current amount. In one embodiment, the light emitting period (E) is performed for a plurality of pixels which emit light concurrently (e.g., simultaneously).

The light emitting period (E) can be set as one of the first light emitting period (E1) or the second light emitting period (E2).

The first light emitting period (E1) represents a period up to a frame finishing point after the scan period (D) in which data writing is finished. For example, the first light emitting period (E1) is not temporally overlapped with the scan period (D). The first light emitting period (E1) may occupy about (or substantially) 40% of one frame. In one embodiment, when the light emitting period (E) is set as the first light emitting period (E1), a duty of the light emitting period (E) is controlled by controlling the time when the second power source voltage (ELVSS) is applied as a low level voltage within the first light emitting period (E1). That is, the duty of the light emitting period (E) may be controllable within a 0 to 40% range of one frame.

The second light emitting period (E2) represents a period from before a time when the scan period (D) starts to the frame finishing point. The second light emitting period (E2) is overlapped with the scan period (D) with respect to time. The second light emitting period (E2) may occupy about (or substantially) 80% of one frame. In this instance, the scan period (D) may occupy about (or substantially) 40% of one frame. When the light emitting period (E) is set as the second light emitting period (E2), the duty of the light emitting period (E) may be controlled by controlling the time when the second power source voltage (ELVSS) is applied as a low level voltage during the second light emitting period (E2). In this instance, the time for the second power source voltage (ELVSS) to be changed to the high level voltage from the low level voltage is set within the time that is not overlapped on the scan time (D), that is, within the E1 time domain. That is, the duty of the light emitting period (E) may be controllable with the 40 to 80% range of one frame.

Accordingly, when the light emitting period (E) is set to be one of the first light emitting period (E1) or the second light emitting period (E2), the time in which the second power source voltage (ELVSS) is changed is not overlapped with the scan period (D) with respect to time. Therefore, the display device 10 according to an embodiment of the present invention may control the duty of the light emitting period (E) while preventing generation of the horizontal dark line caused by temporal superposition of the scan period (D) over the time when the second power source voltage (ELVSS) is varied.

As described with reference to FIG. 3, the duty of the light emitting period (E) may be controllable to correspond to the maximum luminance amount (or size) of the display unit 900.

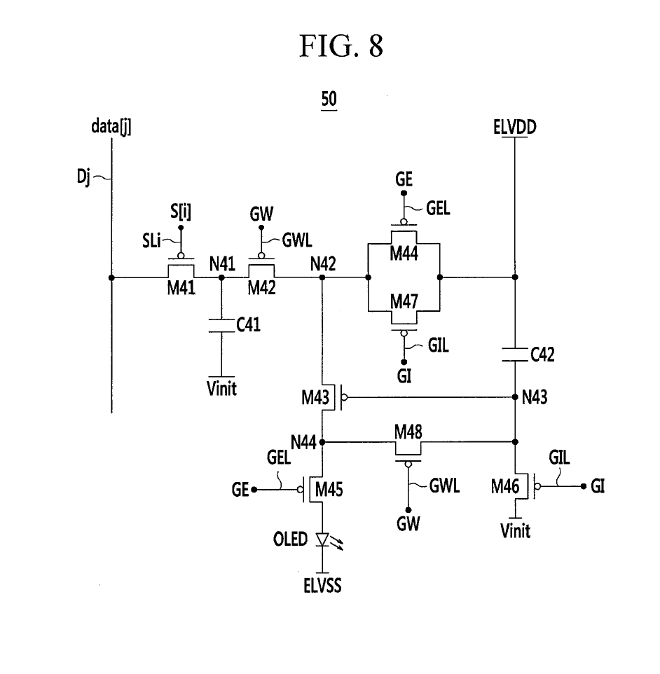

FIG. 8 shows a circuit diagram of a pixel according to another example embodiment of the present invention. That is, one of a plurality of pixels that may be included in the display device 10 of FIG. 1 is shown.

Referring to FIG. 8, the pixel 50 according to a fourth example embodiment includes a switching transistor (M41), a relay transistor (M42), a driving transistor (M43), a first light emitting transistor (M44), a second light emitting transistor (M45), a first reset transistor (M46), a second reset transistor (M47), a compensation transistor (M48), a first capacitor (C41), and a second capacitor (C42). When the pixels included in the display device 10 are of the type represented by the pixel 50 according to the fourth example embodiment, the display device 10 may not include the compensation control signal unit 500.

The switching transistor (M41) includes a gate electrode coupled to a scan line (SLi), a first electrode coupled to a data line (Dj), and a second electrode coupled to a first node (N41). The switching transistor (M41) is turned on by a scan signal (S[i]) with a gate-on voltage applied to the scan line (SLi) and transmits the data voltage (data[j]) applied to the data line (Dj) to the first node (N41).

The relay transistor (M42) includes a gate electrode coupled to a relay line (GWL), a first electrode coupled to the first node (N41), and a second electrode coupled to the second node (N42). The relay transistor (M42) is turned on by the relay signal (GW) with a gate-on voltage applied to the relay line (GWL) and transmits a voltage at the first node (N41) to the second node (N42).

The driving transistor (M43) includes a gate electrode coupled to the third node (N43), a first electrode coupled to the second node (N42), and a second electrode coupled to the fourth node (N44). The driving transistor (M43) controls the driving current supplied to the organic light emitting diode from the first power source voltage (ELVDD).

The first light emitting transistor (M44) includes a gate electrode coupled to a light emitting line (GEL), a first electrode coupled to the first power source voltage (ELVDD), and a second electrode coupled to the second node (N42). The first light emitting transistor (M44) is turned on by a light emitting signal (GE) with a gate-on voltage applied to the light emitting line (GEL) and transmits the first power source voltage (ELVDD) to the second node (N42).

The second light emitting transistor (M45) includes a gate electrode coupled to the light emitting line (GEL), a first electrode coupled to the fourth node (N44), and a second electrode coupled to the organic light emitting diode. The second light emitting transistor (M45) is turned on by the light emitting signal (GE) with a gate-on voltage applied to the light emitting line (GEL) and transmits a voltage at the fourth node (N44) to the organic light emitting diode.

The first reset transistor (M46) includes a gate electrode coupled to a reset line (GIL), a first electrode coupled to an initialization voltage (Vinit), and a second electrode coupled to the third node (N43). The first reset transistor (M46) is turned on by a reset signal (GI) with a gate-on voltage applied to the reset line (GIL) and transmits the initialization voltage (Vinit) to the third node (N43).

The second reset transistor (M47) includes a gate electrode coupled to the reset line (GIL), a first electrode coupled to the first power source voltage (ELVDD), and a second electrode coupled to the second node (N42). The second reset transistor (M47) is turned on by the reset signal (GI) with a gate-on voltage applied to the reset line (GIL) and transmits the first power source voltage (ELVDD) to the second node (N42).

The compensation transistor (M48) includes a gate electrode coupled to the relay line (GW), a first electrode coupled to the third node (N43), and a second electrode coupled to the fourth node (N44). The compensation transistor (M48) is turned on by the relay signal (GW) with a gate-on voltage applied to the relay line (GW) and diode-couples the driving transistor (M43).

The first capacitor (C41) includes a first electrode coupled to the first node (N41) and a second electrode coupled to the initialization voltage (Vinit).

The second capacitor (C42) includes a first electrode coupled to the first power source voltage (ELVDD) and a second electrode coupled to the third node (N43).

The organic light emitting diode (OLED) includes an anode coupled to the second electrode of the second light emitting transistor (M45) and a cathode coupled to the second power source voltage (ELVSS). In one embodiment, the organic light emitting diode includes an organic emission layer for emitting light with one of the primary colors. The primary colors may include red, green, and blue, and desired colors may be expressed by a spatial sum or a temporal sum of the primary colors.

In one embodiment, the switching transistor (M41), the relay transistor (M42), the driving transistor (M43), the first light emitting transistor (M44), the second light emitting transistor (M45), the first reset transistor (M46), the second reset transistor (M47), and the compensation transistor (M48) may be p-channel field effect transistors. In this instance, the gate-on voltage for turning on the switching transistor (M41), the relay transistor (M42), the driving transistor (M43), the first light emitting transistor (M44), the second light emitting transistor (M45), the first reset transistor (M46), the second reset transistor (M47), and the compensation transistor (M48) is a low level voltage and the gate-off voltage for turning them off is a high level voltage.

While the p-channel field effect transistors are used in the embodiment of FIG. 8, at least one of the switching transistor (M41), the relay transistor (M42), the driving transistor (M43), the first light emitting transistor (M44), the second light emitting transistor (M45), the first reset transistor (M46), the second reset transistor (M47), and the compensation transistor (M48) may be an n-channel field effect transistor. In this instance, the gate-on voltage for turning on the n-channel field effect transistor is a high level voltage, and the gate-off voltage for turning it off is a low level voltage.

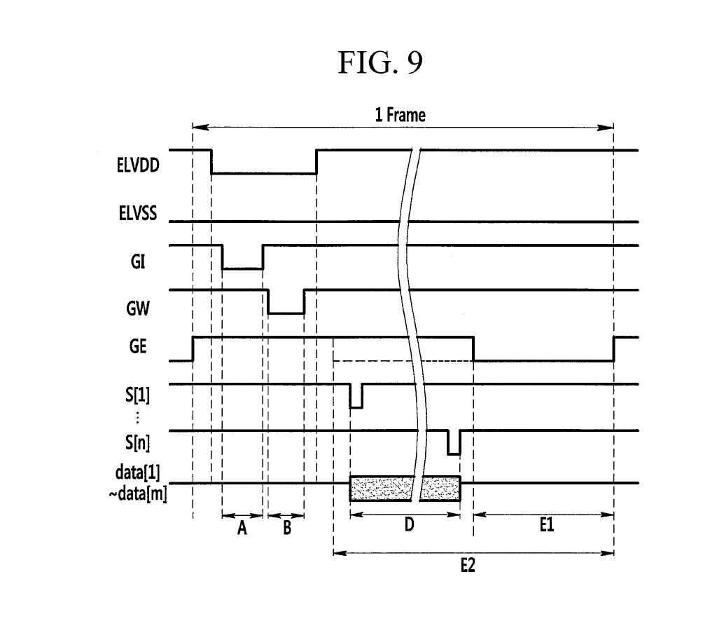

FIG. 9 shows a timing diagram of a method for driving a display device according to another example embodiment of the present invention. That is, FIG. 9 shows a method for driving a display device 10 including the pixel 50 according to the fourth example embodiment.

Referring to FIGS. 1, 8, and 9, one frame period for displaying an image to the display unit 900 includes: a reset period (A) for resetting the driving voltage of the organic light emitting diode of the pixel; a compensating period (B) for compensating a threshold voltage of the driving transistor of the pixel; a scan period (D) for transmitting the data voltage to the pixels; and a light emitting period (E) for emitting light from the pixels corresponding to the data voltage relayed to the gate voltage of the driving transistor.

During the reset period (A), the first power source voltage (ELVDD) and the second power source voltage (ELVSS) are applied as a low level voltage. In this instance, the reset signal (GI) is applied as a gate-on voltage. The first reset transistor (M46) and the second reset transistor (M47) are turned on by the reset signal (GI). As the first reset transistor (M46) is turned on, the initialization voltage (Vinit) is transmitted to the third node (N43). As the second reset transistor (M47) is turned on, the first power source voltage (ELVDD) is transmitted to the second node (N42). That is, the gate electrode of the driving transistor (M43) and the first electrode of the driving transistor (M43) are reset with the initialization voltage (Vinit).

During the compensating period (B), the first power source voltage (ELVDD) and the second power source voltage (ELVSS) are applied as a low level voltage. In this instance, the relay signal (GW) is applied as a gate-on voltage. The relay transistor (M42) and the compensation transistor (M48) are turned on by the relay signal (GW). As the compensation transistor (M48) is turned on, the driving transistor (M43) is diode-coupled. As the relay transistor (M42) is turned on, the first node (N41) is coupled to the second node (N42), and the voltage stored in the first capacitor (C41) is transmitted to the second node (N42). The first capacitor (C41) stores the data voltage that is applied in the previous frame. That is, the data voltage applied in the previous frame is transmitted to the second node (N42). Since the driving transistor (M43) is diode-coupled, the voltage of the data voltage and the threshold voltage of the driving transistor (M43) is transmitted to the third node (N43) and is then stored in the second capacitor (C42). That is, the threshold voltage of the driving transistor (M43) may be compensated. In this instance, the second light emitting transistor (M45) is turned off so the organic light emitting diode does not emit light.

During the scan period (D), a plurality of scan signals (S[1]-S[n]) with a gate-on voltage are sequentially applied to a plurality of scan lines, and a plurality of corresponding data voltages (data[1]-data[m]) are applied. The switching transistor (M41) is turned on by the scan signal (S[i]) with a gate-on voltage, and the data voltage (data[j]) applied to the data line (Dj) is transmitted to the first node (N41) through the turned on switching transistor (M41). Hence, the data voltage (data[j]) is stored in the first capacitor (C41). The data voltage (data[j]) stored in the first capacitor (C41) is used for light emission in the next frame.

During the light emitting period (E), the first power source voltage (ELVDD) is applied as a high level voltage and the second power source voltage (ELVSS) is applied as a low level voltage. The light emitting period (E) is set by the time when the light emitting signal (GE) is applied as a gate-on voltage. When light emitting signal (GE) is applied as a gate-on voltage, the first light emitting transistor (M44) and the second light emitting transistor (M45) are turned on. As the first light emitting transistor (M44) is turned on, the first power source voltage (ELVDD) is coupled to the second node (N42), and as the second light emitting transistor (M45) is turned on, the driving transistor (M43) is coupled to the organic light emitting diode. Hence, the driving transistor (M43) is turned on and the driving current flows to the organic light emitting diode from the first power source voltage (ELVDD). The driving current flows with a current amount that corresponds to the data voltage applied to the third node (N43). The organic light emitting diode (OLED) emits light with brightness that corresponds to the current amount. In one embodiment, the light emitting period (E) is applied to a plurality of pixels that concurrently (e.g., simultaneously) emit light.

The light emitting period (E) can be set as one of the first light emitting period (E1) or the second light emitting period (E2).

The first light emitting period (E1) represents a period up to a frame finishing point after the scan period (D) in which data writing is finished. For example, the first light emitting period (E1) is not temporally overlapped with the scan period (D). The first light emitting period (E1) may occupy about (or substantially) 40% of one frame. In one embodiment, when the light emitting period (E) is set as the first light emitting period (E1), the duty of the light emitting period (E) is controlled by controlling the time when the light emitting signal (GE) is applied as a gate-on voltage within the first light emitting period (E1).

That is, the duty of the light emitting period (E) may be controllable within a 0 to 40% range of one frame.

The second light emitting period (E2) represents a period from before a time when the scan period (D) starts to the frame finishing point. The second light emitting period (E2) is overlapped with the scan period (D) with respect to time. The second light emitting period (E2) may occupy about (or substantially) 80% of one frame. In this instance, the scan period (D) may occupy about (or substantially) 40% of one frame. When the light emitting period (E) is set as the second light emitting period (E2), the duty of the light emitting period (E) may be controlled by controlling the time when the light emitting signal (GE) is applied as a gate-on voltage within the second light emitting period (E2). In this instance, the time when the light emitting signal (GE) is applied as a gate-on voltage is set within the time in which it is not overlapped with the scan time (D), that is, within the E1 time domain. That is, the duty of the light emitting period (E) may be controllable with the 40 to 80% range of one frame.

As described with reference to FIG. 3, the duty of the light emitting period (E) may be controllable to correspond to the maximum luminance amount (or size) of the display unit 900.

As described above, the display device 10 according to embodiments of the present invention selects one of the first light emitting period (E1) or the second light emitting period (E2) as the light emitting period (E) and controls the duty of the light emitting period (E), thereby more freely controlling the duty of the light emitting period (E) between 0%, the minimum light emitting duty, and 80%, the maximum light emitting duty, without influencing image quality.

At least one of a plurality of transistors included in the pixels (20, 30, 40, and 50) according to the first to fourth example embodiments may be an oxide thin film transistor (oxide TFT) with a semiconductor layer made of an oxide semiconductor.

The oxide semiconductor may include one of an oxide that is made based on titanium (Ti), hafnium (Hf), zirconium (Zr), aluminum (Al), tantalum (Ta), germanium (Ge), zinc (Zn), gallium (Ga), tin (Sn), or indium (In), and complex oxides thereof such as zinc oxide (ZnO), indium-gallium-zinc oxide (InGaZnO4), indium-zinc oxide (Zn—In—O), zinc-tin oxide (Zn—Sn—O), indium-gallium oxide (In—Ga—O), indium-tin oxide (In—Sn—O), indium-zirconium oxide (In—Zr—O), indium-zirconium-zinc oxide (In—Zr—Zn—O), indium-zirconium-tin oxide (In—Zr—Sn—O), indium-zirconium-gallium oxide (In—Zr—Ga—O), indium-aluminum oxide (In—Al—O), indium-zinc-aluminum oxide (In—Zn—Al—O), indium-tin-aluminum oxide (In—Sn—Al—O), indium-aluminum-gallium oxide (In—Al—Ga—O), indium-tantalum oxide (In—Ta—O), indium-tantalum-zinc oxide (In—Ta—Zn—O), indium-tantalum-tin oxide (In—Ta—Sn—O), indium-tantalum-gallium oxide (In—Ta—Ga—O), indium-germanium oxide (In—Ge—O), indium-germanium-zinc oxide (In—Ge—Zn—O), indium-germanium-tin oxide (In—Ge—Sn—O), indium-germanium-gallium oxide (In—Ge—Ga—O), titanium-indium-zinc oxide (Ti—In—Zn—O), and hafnium-indium-zinc oxide (Hf—In—Zn—O).

The semiconductor layer may include a channel region that is not doped with impurities, and a source region and drain region doped with impurities on both sides of the channel region. These impurities may vary depending on the type of the thin film transistor, and may be an N-type impurity or a P-type impurity.

When the semiconductor layer is made of an oxide semiconductor, an extra protection layer may be added in order to protect the oxide semiconductor that may be vulnerable to the external environment such as by being exposed to a high temperature.

The organic emission layer of an organic light emitting diode according to embodiments of the present invention may be made of a low molecular organic material or a polymeric organic material such as poly(3,4-ethylenedioxythiophene) (PEDOT). Also, the organic emission layer may be formed with multilayers including at least one of an emission layer, a hole injection layer (HIL), a hole transport layer (HTL), an electron transport layer (ETL), and an electron injection layer (EIL). In an embodiment where all of these are included, the hole injection layer (HIL) may be disposed on the pixel electrode that is an anode, and a hole transport layer (HTL), an emission layer, an electron transport layer (ETL), and an electron injection layer (EIL) may be sequentially stacked on the hole injection layer HIL.

The organic emission layer may include a red organic emission layer to light-emit red, a green organic emission layer to light-emit green, and a blue organic emission layer to light-emit blue, and the red organic emission layer, the green organic emission layer, and the blue organic emission layer may be formed in a red pixel, a green pixel, and a blue pixel, respectively, to realize color images.

Further, the organic emission layer may be stacked together with the red organic emission layer, the green organic emission layer, and the blue organic emission layer in the red pixel, the green pixel, and the blue pixel, respectively, to form a red color filter, a green color filter, and a blue color filter for each pixel and to implement color images. As another example, a white organic emission layer to light-emit white may be formed in all of the red pixel, the green pixel, and the blue pixel to form the red color filter, the green color filter, and the blue color filter for each pixel, respectively, and to implement the color images. When the color image is implemented using the white organic emission layer and the color filters, the red organic emission layer, the green organic emission layer, and the blue organic emission layer do not require a deposition mask to be deposited for each pixel (e.g., color pixel), that is, the red pixel, the green pixel, and the blue pixel.

A white organic emission layer described in another example may be formed of one organic emission layer, and may include a configuration to light-emit the white by the plurality of organic emission layers. For example, a configuration to light-emit the white by combining at least one yellow organic emission layer and at least one blue organic emission layer, a configuration to light-emit the white by combining at least one cyan organic emission layer and at least one red organic emission layer, and a configuration to light-emit the white by combining at least one magenta organic emission layer and at least one green organic emission layer may also be included.

The drawings and the detailed description above are examples for the present invention and are provided to explain the present invention, and the scope of the present invention described in the claims is not limited thereto. Therefore, it will be appreciated by those skilled in the art that various modifications may be made and other equivalent embodiments are available. Accordingly, the actual scope of the present invention must be determined by the spirit and scope of the appended claims and their equivalents.

What is claimed is:

1. A display device comprising:
a plurality of pixels, wherein
each of the pixels comprises:
a switching transistor comprising a gate electrode for receiving a scan signal, a first electrode coupled to a data line, and a second electrode coupled to a first node;
a relay transistor comprising a gate electrode for receiving a relay signal, a first electrode coupled to the first node, and a second electrode coupled to a second node;
a first capacitor comprising a first electrode coupled to the second node and a second electrode coupled to a third node;
a driving transistor comprising a gate electrode coupled to the third node, a first electrode coupled to a first power source voltage, and a second electrode coupled to a fourth node; and
an organic light emitting diode (OLED) comprising an anode coupled to the fourth node and a cathode coupled to a second power source voltage,
wherein the OLED emits light according to a driving current flowing to the OLED from the first power source voltage, and a light emitting period for the OLED to emit light is one of a first light emitting period that is not temporally overlapped with a scan period in which data are written to the pixels or a second light emitting period that is temporally overlapped with the scan period, and
wherein a duty of the light emitting period is controlled by controlling a time when the second power source voltage is applied as a low level voltage within the first light emitting period or controlling a time when the second power source voltage is applied as a low level voltage within the second light emitting period.

2. The display device of claim 1, wherein
when the light emitting period is concurrently performed for the pixels, the relay transistor is turned off, the switching transistor is turned on by a scan signal having a gate-on voltage corresponding to the pixels, and a data voltage applied to the data line is transmitted to the first node.

3. The display device of claim 1, wherein
the duty of the light emitting period is controlled according to a maximum luminance of a display unit comprising the pixels.

4. The display device of claim 1, wherein
each of the pixels further comprises
a compensation transistor comprising a gate electrode for receiving a compensation control signal, a first electrode coupled to the third node, and a second electrode coupled to the fourth node.

5. The display device of claim 4, wherein
each of the pixels further comprises
a reset transistor comprising a gate electrode for receiving the compensation control signal, a first electrode coupled to the data line, and a second electrode coupled to the second node.

6. The display device of claim 5, wherein
each of the pixels further comprises
a second capacitor comprising a first electrode coupled to the first power source voltage and a second electrode coupled to the second node.

7. The display device of claim 6, wherein
each of the pixels further comprises
a third capacitor comprising a first electrode coupled to the first node and a second electrode for receiving the compensation control signal.

8. The display device of claim 4, wherein
each of the pixels further comprises
a reset transistor comprising a gate electrode for receiving a reset signal, a first electrode coupled to the first power source voltage, and a second electrode coupled to the second node.

9. The display device of claim 8, wherein
each of the pixels further comprises
a second capacitor comprising a first electrode coupled to a reference voltage and a second electrode coupled to the first node.

10. A display device comprising
a plurality of pixels, wherein
each of the pixels comprises:
a switching transistor comprising a gate electrode for receiving a first scan signal and a first electrode coupled to a data line;
a compensation transistor comprising a gate electrode coupled to a first node, a first electrode coupled to a second electrode of the switching transistor, and a second electrode coupled to the first node;
a relay transistor comprising a gate electrode for receiving a relay signal, a first electrode coupled to the first node, and a second electrode coupled to a second node;
a driving transistor comprising a gate electrode coupled to the second node and a first electrode coupled to a first power source voltage; and
an organic light emitting diode (OLED) comprising an anode coupled to a second electrode of the driving transistor and a cathode coupled to a second power source voltage,
wherein the OLED emits light according to a driving current flowing to the OLED from the first power source voltage, and a light emitting period for the OLED to emit light is one of a first light emitting period that is not temporally overlapped with a scan period in which data are written to the pixels or a second light emitting period that is temporally overlapped with the scan period, and
wherein a duty of the light emitting period is controlled by controlling a time when the second power source voltage is applied as a low level voltage within the first light emitting period or controlling a time when the second power source voltage is applied as a low level voltage within the second light emitting period.

11. The display device of claim 10, wherein
when the light emitting period is concurrently performed for the pixels, the relay transistor is turned off, the switching transistor is turned on by a scan signal having a gate-on voltage corresponding to the pixels, and a data voltage applied to the data line is transmitted to the first node.

12. The display device of claim 10, wherein
the duty of the light emitting period is controlled according to a maximum luminance of a display unit comprising the pixels.

13. The display device of claim 10, wherein
each of the pixels further comprises
a first reset transistor comprising a gate electrode for receiving a second scan signal that is received before the first scan signal in a previous row, a first electrode coupled to a reference voltage, and a second electrode coupled to the first node.

14. The display device of claim 13, wherein
each of the pixels further comprises
the second reset transistor comprising a gate electrode for receiving a reset signal, a first electrode coupled to the reference voltage, and a second electrode coupled to the second node.

15. The display device of claim 14, wherein
each of the pixels further comprises
a first capacitor comprising a first electrode coupled to the first power source voltage and a second electrode coupled to the first node.

16. The display device of claim 15, wherein
each of the pixels further comprises
a second capacitor comprising a first electrode coupled to the first power source voltage and a second electrode coupled to the second node.

17. A display device comprising
a plurality of pixels, wherein
each of the pixels comprises:
a switching transistor comprising a gate electrode for receiving a scan signal, a first electrode coupled to a data line, and a second electrode coupled to a first node;
a relay transistor comprising a gate electrode for receiving a relay signal, a first electrode coupled to the first node, and a second electrode coupled to a second node;
a driving transistor comprising a gate electrode coupled to a third node, a first electrode coupled to the second node, and a second electrode coupled to a fourth node;
a first light emitting transistor comprising a gate electrode for receiving a light emitting signal, a first electrode coupled to a first power source voltage, and a second electrode coupled to the second node; and
a second light emitting transistor comprising a gate electrode for receiving the light emitting signal, a first electrode coupled to the fourth node, and a second electrode coupled to an organic light emitting diode (OLED),
wherein the OLED emits light according to a driving current flowing to the OLED from the first power source voltage, and a light emitting period for the OLED to emit light is one of a first light emitting period that is not temporally overlapped with a scan period in which data are written to the pixels or a second light emitting period that is temporally overlapped with the scan period, and
wherein a duty of the light emitting period is controlled by controlling a time when the light emitting signal is applied as a gate-on voltage within the first light emitting period or controlling a time when the light emitting signal is applied as a gate-on voltage within the second light emitting period.

18. The display device of claim 17, wherein
when the light emitting period is concurrently performed for the pixels, the relay transistor is turned off, the switching transistor is turned on by a scan signal having a gate-on voltage corresponding to the pixels, and a data voltage applied to the data line is transmitted to the first node.

19. The display device of claim 17, wherein
the duty of the light emitting period is controlled according to a maximum luminance of a display unit comprising the pixels.

20. The display device of claim 17, wherein
each of the pixels further comprises
a first reset transistor comprising a gate electrode for receiving a reset signal, a first electrode coupled to an initialization voltage, and a second electrode coupled to the third node.

21. The display device of claim 20, wherein
each of the pixels further comprises
a second reset transistor comprising a gate electrode for receiving the reset signal, a first electrode coupled to the first power source voltage, and a second electrode coupled to the second node.

22. The display device of claim 21, wherein
each of the pixels further comprises
a compensation transistor comprising a gate electrode for receiving the relay signal, a first electrode coupled to the third node, and a second electrode coupled to the fourth node.

23. The display device of claim 22, wherein
each of the pixels further comprises
a first capacitor comprising a first electrode coupled to the first node and a second electrode coupled to the initialization voltage.

24. The display device of claim 23, wherein
each of the pixels further comprises
a second capacitor comprising a first electrode coupled to the first power source voltage and a second electrode coupled to the third node.

25. A method for driving a display device comprising a plurality of pixels, each of the pixels comprising a switching transistor for coupling a data line and a first node, a relay transistor for coupling the first node and a second node, a first capacitor coupled between the second node and a third node, and a driving transistor having a gate electrode coupled to the third node and configured to control a driving current flowing to an organic light emitting diode (OLED) from a first power source voltage, the method comprising:
in a scan period of a first frame, turning off the relay transistor and turning on the switching transistor to transmit a data voltage applied to the data line to the first node; and
in a light emitting period of the first frame, turning on the driving transistor according to a voltage at the third node and emitting light from the OLED according to the driving current, wherein
the voltage at the third node corresponds to a data voltage transmitted to the first node during a scan period of a frame that is before the first frame, and
the pixels emit light during a light emitting period of the first frame, the light emitting period of the first frame being one of a first light emitting period that is not temporally overlapped with a scan period of the first frame or a second light emitting period that is temporally overlapped with the scan period of the first frame, and
wherein a duty of the light emitting period of the first frame is controlled by controlling a time when a second power source voltage coupled to a cathode of the OLED is applied as a low level voltage within the first light emitting period or controlling a time when the second power source voltage is applied as a low level voltage within the second light emitting period.

26. The method of claim 25, wherein
the duty of the light emitting period is controlled according to a maximum luminance of a display unit comprising the pixels.

27. A method for driving a display device comprising a plurality of pixels, each of the pixels comprising a switching transistor for transmitting a data voltage to a first electrode of a compensation transistor having a gate electrode and a second electrode coupled to a first node, a relay transistor for coupling the first node and a second node, and a driving transistor having a gate electrode coupled to the second node and configured to control a driving current flowing to an organic light emitting diode (OLED) from a first power source voltage, the method comprising:
in a scan period of a first frame, turning off the relay transistor and turning on the switching transistor and the compensation transistor to transmit the data voltage to the first node; and
in a light emitting period of the first frame, turning on the driving transistor according to a voltage at the second node and emitting light from the OLED according to the driving current, wherein
the voltage at the second node corresponds to a data voltage transmitted to the first node during a scan period of a frame that is before the first frame, and
the pixels emit light during a light emitting period of the first frame, the light emitting period of the first frame being one of a first light emitting period that is not temporally overlapped with a scan period of the first frame or a second light emitting period that is temporally overlapped with the scan period of the first frame, and
wherein a duty of the light emitting period of the first frame is controlled by controlling a time when a second power source voltage coupled to a cathode of the OLED is applied as a low level voltage within the first light emitting period or controlling a time when the second power source voltage is applied as a low level voltage within the second light emitting period.

28. The method of claim 27, wherein
the duty of the light emitting period is controlled according to a maximum luminance of a display unit comprising the pixels.

29. A method for driving a display device comprising a switching transistor for coupling a data line and a first node, a relay transistor for coupling the first node and a second node, a first light emitting transistor for coupling the second node and a first power source voltage, a capacitor coupled between the first power source voltage and a third node, a driving transistor having a gate electrode coupled to the third node and coupling the second node and a fourth node, and being configured to control a driving current flowing to an organic light emitting diode (OLED) from the first power source voltage, and a second light emitting transistor for coupling the fourth node and the OLED, the method comprising:
in a scan period of a first frame, turning off the relay transistor and turning on the switching transistor to transmit a data voltage applied to the data line to the first node; and
in a light emitting period of the first frame, turning on the first light emitting transistor and the second light emitting transistor according to a light emitting signal, turning on the driving transistor according to a voltage at the third node, and emitting light from the OLED according to the driving current, wherein
the voltage at the third node corresponds to a data voltage transmitted to the first node during a scan period of a frame that is before the first frame, and
the pixels emit light during a light emitting period of the first frame, the light emitting period of the first frame being one of a first light emitting period that is not temporally overlapped with a scan period of the first frame or a second light emitting period that is temporally overlapped with the scan period of the first frame, and
wherein a duty of the light emitting period of the first frame is controlled by controlling a time when the light emitting signal is applied as a gate-on voltage within the first light emitting period or controlling a time when the light emitting signal is applied as a gate-on voltage within the second light emitting period.

30. The method of claim 29, wherein
the duty of the light emitting period is controlled according to a maximum luminance of a display unit comprising the pixels.
